(19) United States
(12) Patent Application Publication
(10) Pub. No.: US 2022/0414638 A1
(43) Pub. Date: Dec. 29, 2022

(54) METHOD AND SYSTEM FOR COMMUNICATION BETWEEN A CHIP CARD READER AND AN EXTERNAL DEVICE

(71) Applicant: THALES DIS FRANCE SAS, MEUDON (FR)

(72) Inventors: Pierre PALADJIAN, ALLAUCH (FR); Ali ZEAMARI, MARSEILLE (FR); Frédéric MARTINEZ, MARSEILLE (FR)

(73) Assignee: THALES DIS FRANCE SAS, MEUDON (FR)

(21) Appl. No.: 17/774,297

(22) PCT Filed: Oct. 29, 2020
(86) PCT No.: PCT/EP2020/080368

§ 371 Date: Sep. 12, 2022

(30) Foreign Application Priority Data
Nov. 5, 2019 (EP) 19306431.8

(51) Int. Cl. G06Q 20/32; G06Q 20/20; G06Q 20/34

(52) U.S. Cl. CPC G06Q 20/327; G06Q 20/202; G06Q 20/352; G06Q 20/1085

(57) ABSTRACT

The invention relates to a method for performing a transaction with a system (1, 1A, 1B, 10) comprising a terminal (2) and a chip device (3), said system being configured to communicate to a user (6), during said transaction, transaction information from the terminal via an adapter (4), said adapter being configured to receive, by wire or wirelessly, said information (5) and to translate it into voice or another form, said information being obtained or collected in or via said chip device (3), characterized in that said chip device (3) is configured with a first communication interface with proximity radiofrequency or electrical (M3) contacts included in the device in order to receive the transaction information directly from a communication interface of the terminal. The invention also relates to the corresponding system.

### FIELD OF THE INVENTION

The invention relates to a method for performing a transaction with a system comprising a transaction terminal (or reader), in particular a banking terminal, and a personal transaction device, in particular a payment device, such as a chip card and to communicate transaction information to a user during the transaction via an adapter.

More particularly, the adapter may be configured to receive, by wire or wirelessly, said information and to translate it into voice or another form that the user can perceive.

The adapter may be chosen among, in particular, electronic communication devices (cell phone, tablet, PDA personal assistant, wearable electronic accessories such as smart or NFC watches).

The personal transaction device, in particular a payment device, may also be any medium for transaction applications, in particular payment applications, or any transaction device, in particular a payment device, preferentially represented by a chip card. Some chip cards may comprise user interfaces (screen, keypad, biometric sensor, etc.) and/or various communication interfaces (NFC, ISO 7816, Bluetooth™, etc.).

Some of these transaction devices are intended for electronic transactions, in particular financial transactions, such as purchases that can be made online via the Internet on merchant sites, but also locally at merchants' premises using a POS terminal (Point of Sale Terminal) or an ATM (Automatic Teller Machine), vending machines for goods such as fuel, beverages, etc., in company restaurants, stores, etc.

### PRIOR ART

It has been proposed or recommended, in particular in accordance with supranational guidelines, for POS terminals to be equipped with a communication interface other than a display, for example an audio output or another type of output, to allow visually impaired persons to be informed about the transaction data.

Document FR2793361 A1 discloses an electronic transaction system between a transport terminal and a chip card with electrical contacts housed in a smart case with a contactless interface. The case includes a battery, an electrical interface to supply power and information to the card, an audio interface for the user and a wireless communication interface to carry out the electronic transaction with the terminal. The information is received by the card via its contact interface through the remote communication case placed between the card and the terminal. The communication interface of the terminal is of wireless type, which enables in particular the communication of information to the user after the transaction.

### TECHNICAL PROBLEM

During a banking transaction, with electrical contacts or contactless, the user only sees the information displayed on the POS payment terminal. However, some people (for example, the visually impaired) are not able to see this information. It is therefore currently necessary to inform the user differently about the transaction information.

The type of solution mentioned above, with an interface (other than a display) directly on the payment terminal and capable of transmitting the transaction information to a user, is not currently deployed and does not seem to be practical to deploy on existing banking equipment.

### OBJECTIVE OF THE INVENTION

The invention aims in particular to solve the abovementioned disadvantages or to meet the need identified hereinbefore.

In particular, it seeks to achieve this goal while making the fewest technical changes to the associated hardware or software infrastructure currently deployed or while being as cost-effective as possible.

### SUMMARY OF THE INVENTION

For this purpose, the object of the invention is a method for performing a transaction with a system comprising a transaction terminal (in particular a banking terminal) and a transaction device (in particular a banking device), said system being configured to communicate to a user, during said transaction, transaction information from the terminal (or reader) via an adapter, said adapter being configured to receive, by wire or wirelessly, said information and to translate it into voice or another form, said information being obtained or collected in or via said transaction device, characterized in that said chip device (or transaction device) is configured with a first communication interface with proximity radiofrequency or electrical contacts included in the device in order to receive the transaction information directly from a communication interface of the terminal.

According to other characteristics or preferred embodiments:
The chip device may be configured with a second integrated wireless communication interface to communicate said information to the adapter;
The first interface of the device may comply with ISO standard 7816 or 14443 and/or ISO/IEC 18092;
The second wireless communication interface (14, 34) may be selected from Bluetooth, Wi-Fi, UHF, NFC, Li-Fi.
The method may comprise the preferred step whereby, in order to perform the transaction, the device may be presented alone to the terminal (with no intermediate apparatus, intermediate device, communication adapter, accessory) or inserted alone into said terminal;
The transaction information may be derived in parallel from the information received by said chip device;
The transaction information may be processed or selected by the chip of the device;
The adapter may comprise a cell phone, a wireless earpiece provided with a communication interface adapted to that of the communication interface of the personal transaction device (or the card);
The adapter may be selected from a user device such as a cell phone, a tablet, a PDA, a wearable electronic accessory, a smart or NFC watch).
the reader (or terminal) may comprise a POS reader or ATM banking terminal;
The adapter may comprise a software application configured to translate or transpose digital or analog information into voice or another type of information on a human-machine interface and vice-versa.
The software application may also make it possible to translate into any language and/or any currency the information received in particular the amount of the transaction.

The object of the invention is also a system corresponding to the method hereinbefore. In particular, its object is a system for performing a transaction comprising a terminal (or chip card reader) and a personal transaction device (or a chip card), said system being configured to communicate to a user, during said transaction, transaction information from the terminal via an adapter, said adapter being configured to receive, by wire or wirelessly, said information and to translate it into voice or another form, said information being obtained or collected in or via said personal transaction device,

characterized in that said chip device (or personal transaction device) is configured with a first communication interface with proximity radiofrequency or electrical contacts included in the device in order to receive the transaction information directly from a communication interface of the terminal.

An object of the invention is also a personal transaction device (such as a chip card) for performing a transaction with a terminal according to the method hereinbefore, characterized in that it is configured so as to obtain or collect transaction information directly from the terminal and to communicate it to an associated adapter with which it is paired.

An object of the invention is also an adapter for implementing the method hereinbefore, said transaction adapter being configured to receive, by wire or wirelessly, transaction information from a terminal (or a reader) and to translate it into voice or another form, during a transaction, characterized in that it is paired with a personal transaction device (or chip card) so as to receive said transaction information of an electronic transaction carried out with said terminal.

### BRIEF DESCRIPTION OF THE FIGURES

FIG. 1 shows a general system for performing transactions according to general embodiments of the method of the invention;

FIGS. 2 and 3 respectively show a first embodiment of the transaction system as well as an example of operation;

FIGS. 4 and 5 respectively show a second embodiment of the transaction system as well as an example of operation;

FIGS. 6 and 7 respectively show a third embodiment of the transaction system as well as an example of operation.

### DESCRIPTION

The same references from one figure to the other, indicate identical or similar components.

The invention is mainly disclosed in relation with a POS terminal, but other readers or terminals may replace it in the various examples. Likewise, a chip card may be replaced with any device disclosed in each of the examples, such as an NFC watch, a phone or watch in card emulation mode.
Likewise, the functions of the telephone and/or of the watch or of the headset or earpiece may be switched in the examples.

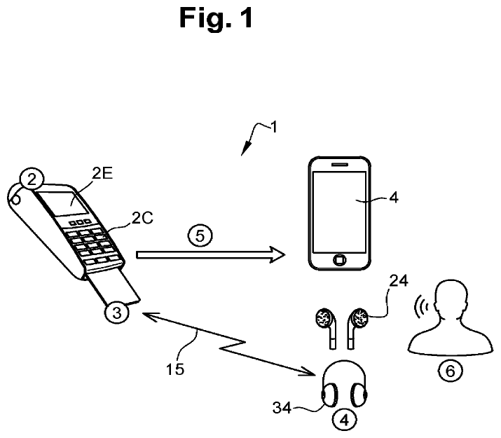

FIG. 1 shows a system for performing a transaction according to a first embodiment of the method of the invention.

The system 1 may comprise only one transaction terminal 2 (or chip card reader) or payment terminal POS, as well as a transaction device 3 such as a chip card.

The terminal 2 may be an ATM, a pay station, a beverage vending machine, any transaction device that performs an electronic transaction with a user's transaction device or a payment device associated with a telephone (e.g. iZetlle, etc.).

According to one characteristic, the system is configured to communicate to a user, during the transaction, transaction information from the terminal (or reader 2) via an adapter 4.

The transaction information may comprise the data normally displayed on a payment terminal, such as the choice of means of payment (debit or credit card), the payment mode (contact or contactless), the amount, the currencies, the request for user validation (via secret code (PIN), signature, biometric verification, or another means), the status of the user validation and of the transaction. Alternatively, the transaction may be an authentication for, in particular, physical and/or logical access to a building a computer network, displayed information such as instructions to a user 6 (wait, enter, etc.), or authentication or validation of the user on an electric or mobile device (e.g. validation or signing of a transaction, an order, an operation, etc.).

This adapter 4 can be configured to receive, by wire or wirelessly, the information 5 and to translate it into voice or another form so that it can be understood by the user 6. It may comprise an application making it possible to pair the adapter with the card in particular using secure communication protocols. Once the pairing is established, the method of the invention may provide for encrypting or encoding all the information received or at least certain sensitive or confidential information. Encryption keys (or secrets) or secret keys may be shared between the card and the adapter in order to encrypt or encode the communication therebetween.

In the prior art, the system 1 may comprise an audio interface (not shown) to which a user can connect an audio headset on the terminal. However, the invention provides for another technical configuration disclosed hereunder.

In the preferred example, the terminal 2 is a bank payment terminal POS, compliant with those currently on the market. It comprises a secure structure and functions approved/standardized for EMV (Europay MasterCard Visa), which is the international standard for secure payment transactions. The POS can be provided in particular with a reader of a contact (or contactless) card 3, and human-machine interface(s) such as a keypad 2C, screen 2E as well as means, in particular NFC (Near Field Communication), for contactless communication with a smart phone 4 or contactless card.

In the example of FIG. 1, the terminal 2 comprises an interface with electrical contacts for exchanging 15 with the card via a terminal block of electrical contacts or a contact module M3 (integrated). The interface (terminal block or NFC antenna) can also make it possible to supply power to the circuits of the device 3.

The terminal 2 can preferably be provided with a secure module with a SAM electronic chip and encrypted electronic means for communicating with a central banking server (in particular for periodic collection of transaction information and/or update information, or for real-time online validation), or a server of (or for) merchants.

Alternatively, the electronic transaction device 3, on the other hand, may constitute or comprise any payment device with banking payment applications, or which may simulate/emulate bank cards (for example a smart watch, tag, electronic payment bracelet, etc.).

The device 3 may be in card form but also alternatively in the form of a smart phone. The telephone may comprise a function for emulating a contactless card according to ISO standard 14443 and/or ISO/IEC 18092 so as to communicate directly with the terminal 2 (POS) by being perceived by the latter as a chip card or a payment device.

The device 3 may also integrate electronic circuits or integrated-circuit chips. It may integrate a human-machine interface, herein in the form of a touch screen. It may integrate applications or programs that operate as applications, stored in memory in particular EEPROM or flash in order to in particular carry out banking operations, loyalty operations or others. These application programs may be executed by a main processing unit μC2, 13 or in one or more electronic circuits or electronic chips with associated integrated circuits such as an electronic security element «eSE in particular in a telephone or a watch».

The device 3 may integrate a function of receiving transaction data from the terminal 2. It may integrate an NFC interface in order to receive transaction data also emitted in NFC radiofrequency mode.

According to one characteristic of the preferred embodiment, the method comprises the step whereby said transaction information communicated to the adapter 4 is obtained or collected in or via said chip card 3 (or another personal transaction device).

According to a first hardware and software implantation or configuration of the transaction device 3 (such as the card), the transaction information 5 may be derived in parallel from the information 15 received by the chip device 3.

For example, the invention may provide an additional spy chip 14 or 34 which is connected in parallel to the communication pads of the chip of the card. The invention may provide an additional electronic chip 14 or 34 (connected to the security element SE, 13 or EMV), which is configured to communicate the necessary information to the user, extracted from the transaction in progress.

Alternatively, the transaction information 5 may be processed or selected by the application chip 13 of the transaction device with a chip. This same chip 13 may transmit this information 5 to another chip (or microcontroller) 14 responsible for transmitting to the outside in particular the adapter 4 via an appropriate communication interface not shown).

The card may be arranged or configured or equipped with a radiofrequency communication interface among Bluetooth, Wi-Fi, UHF, NFC, Li-Fi, infrared, optical to transmit or communicate said information to the adapter 4. This interface may belong or be connected to a corresponding microcontroller 14, in particular BLE. This interface may belong to the chip 13.

According to one characteristic, the adapter 4 may comprise a cell phone 4 or a wireless earpiece 24 provided with a communication interface adapted to that of the communication interface of the personal transaction device 3.

The adapter 4 may preferably comprise a software application 41 configured to translate or transpose digital or analog information 5 (received from the card in particular by any communication in particular BLE) into voice or another type of information on a human-machine interface and vice-versa.

According to a preferred embodiment, the adapter 4 may be similar to the smart phone disclosed hereinbefore. It may also be configured to exchange with the chip card 3 or an internal chip card emulated in the telephone.

The adapter may comprise a cell phone 4, a wireless earpiece 24 provided with a communication interface adapted to that of the communication interface of the chip device 3.

The NFC banking application of the device 3 (which can be in particular in the form of a cell phone, smart watch, etc.) may be configured to extract data from the transaction and transmit it in audio form to the user in particular via a Bluetooth earpiece 24 (or wired or wireless headset 34) connected to the device 3.

### DESCRIPTION OF PARTICULAR EMBODIMENTS

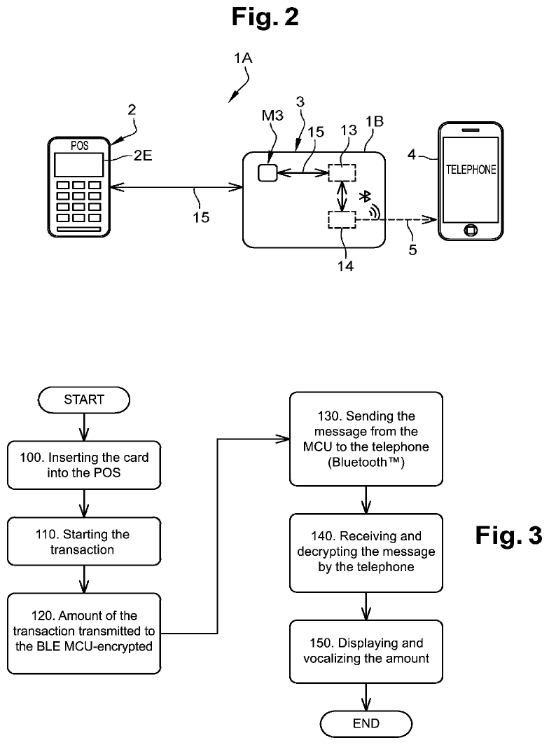

In FIG. 2, the system comprises a card having an application chip 13 in particular an EMV banking chip connected to a contact communication interface M3. The interface may also be an interface with a radiofrequency antenna (not shown. The card interface M3 is configured to establish communication 15 with the terminal 2. The communication can be near field communication (NFC) or communication by electrical contacts. (The NFC or contact interface is integrated in the device or card).

The application chip 13 according to this embodiment may be connected to a microcontroller MCU 14 having a medium-range radiofrequency communication interface. For example, the latter interface may be a BLE (Bluetooth™ Low Energy) interface.

The microcontroller 14 is configured to receive transaction information transmitted by the application chip 13. The latter can be configured to select minimal transaction information that arrives via the terminal 2 such as the information that is normally displayed on the screen of the terminal 2E.

FIG. 3 shows steps relative to the operation of the system 1B of the preceding figure. A user seeking to carry out a purchase from a merchant presents or inserts only (step 100) their bank card (presents their watch, etc.) to the terminal 2. In the example, FIG. 3, the card is inserted into the POS terminal. Then in step 110, the transaction to pay for a purchased article begins with conventional exchanges in accordance with payment standards, in particular EMV, between the terminal 2 and the application chip 13. In step 120, the amount of the transaction is transmitted to the microcontroller 14 BLE MCU. This transmission may be secured and/or the amount may be preferably encrypted. Then, in step 130, the MCU 14 sends a message 5 containing all or part of the information received to the adapter 4, in this case a cell phone. In step 140, the telephone 140 via a dedicated application receives and decrypts the message 5 from the card 3. Then, in step 150, the telephone displays and/or vocalizes the decrypted message received. When applicable, the user has connected an audio headset to their telephone and can receive the audio message in their headset.

Alternatively, the user may have an earpiece paired with their telephone in order to receive the message received by their telephone (adapter). Alternatively, the user may have an earpiece that is configured to receive directly the message emitted by the card via the microcontroller MCU 14.

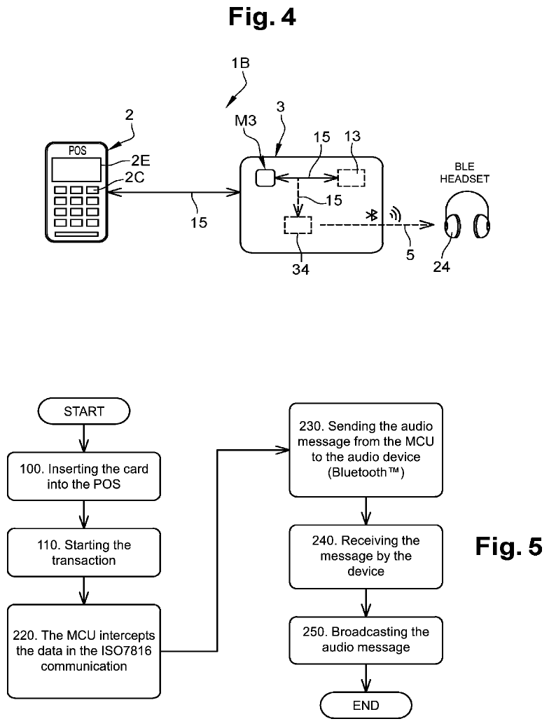

In FIG. 4, the system 1B differs from the preceding system in that the microcontroller 14 is configured to spy on the information 15 exchanged between the chip 13 and the terminal 2 and in that the adapter 4 comprises or consists of an audio peripheral 24 such as an earpiece (or an audio headset). In order to spy, the microcontroller 14 may be connected in parallel to the contact or contactless interface M3 for example. The earpiece or the headset 24 may have the functions disclosed previously in relation to the telephone 4. The adapter of this embodiment can thus comprise all or part of the functions or hardware and software means of the telephone 4

FIG. 5 shows steps relative to the operation of the system 1B of FIG. 4. Steps 100 to 110 are identical to those of the preceding system 1B. In step 220. The MCU 34 intercepts the exchanges 15 in the ISO 7816 communication between the terminal and the application chip 13 in particular EMV and it is configured to transform the collected message 5 (optionally sorted) into an audio signal sent to an audio peripheral 24. Alternatively, the MCU 34 retransmits the digital message to the peripheral and the latter transforms the message into an audio file and broadcasts it to the user.

The MCU 14 can be configured or parameterized to extract only some (5) or all (15) of the exchanged information such as the amount, the type of payment, cash or credit, etc. For example, message content indicators are detected by the MCU 34 in order to extract the information required by the user. The MCU 14 can in particular be configured or parameterized to listen to the entire communication that travels over the ISO 7816 channel, and to extract therefrom the data required by the user.

Then in step 230, the system 1B sends the audio message from the MCU 34 to the audio peripheral (according to a short- or medium-range communication protocol, in particular Bluetooth™ Low Energy (BLE)). Then in step 240, the audio device 24 receives the message (5 or 15) in order to broadcast it subsequently (250) to the user.

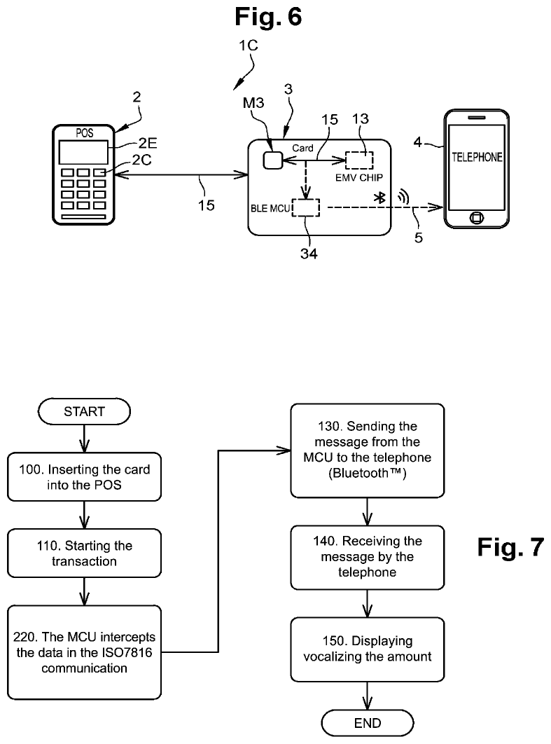

In FIG. 6, the system 10 is similar to that of FIG. 2. It differs simply by the MCU. The MCU 34 which is different herein from the MCU 14 is configured to spy on and extract all or part of the information exchanged between the terminal and the application chip 13 as in the system 1B of FIG. 4. The system 10 also differs in that the digital data or information 5, 15 spied on can be received by the telephone 4 and can be transformed into audio information by the telephone.

In other terms, system 10 (FIG. 6) can differ from system 1B (FIG. 4) only by the adapter 4. System 10 comprises an audio headset connected directly to the transaction device 3 in particular by BLE, or Wi-Fi or any other communication protocol.

FIG. 7 shows steps relative to the operation of the system 10 of the preceding figure.

Steps 100 and 110 are identical to those of FIG. 3. Then step 220 is identical to that of FIG. 2 wherein the MCU 34 intercepts the data by spying on the communication 15 between the terminal 2 and the application chip 13. Then, steps 130 to 150 can be identical to those of FIG. 3, wherein the (optionally encrypted) message sent by the card over BLE and received by the adapter (telephone) is displayed and/or vocalized (transformed by the latter into an audio signal).

For this purpose, in all the examples, the MCU 14, 34 or the adapter 4, 24 may comprise an application configured to transform a file containing a digital message into an audio file. The audio file can then be transformed into a signal that the user can hear through a speaker of the adapter 4 or earpiece or audio headset 24.

1. A method for performing a transaction with a system (1, 1A, 1B, 10) comprising a terminal (2) and a chip device (3), said system being configured to communicate to a user (6), during said transaction, transaction information from the terminal via an adapter (4), said adapter being configured to receive, by wire or wirelessly, said information (5) and to translate it into voice or another form, said information being obtained or collected in or via said chip device (3),
characterized in that said chip device (3) is configured with a first communication interface with proximity radiofrequency or electrical contacts (M3) included in the device in order to receive the transaction information directly from a communication interface of the terminal.

2. The method according to the preceding claim, characterized in that said chip device (3) is configured with a second integrated wireless communication interface (14, 34) for communicating said information to the adapter.

3. The method according to one of the preceding claims, characterized in that said first interface of the device (3) complies with ISO standard 7816 (M3) or ISO 14443 and/or ISO/IEC 18092.

4. The method according to one of claim 2 or 3, characterized in that said second wireless communication interface (14, 34) is selected from Bluetooth, Wi-Fi, UHF, NFC, Li-Fi.

5. The method according to the preceding claim, characterized in that it comprises the step whereby, in order to perform the transaction, the device is presented alone to the terminal or inserted alone into said terminal (2).

6. The method according to the preceding claim, characterized in that said transaction information (5) is derived in parallel from the information received by said chip device.

7. The method according to the preceding claim, characterized in that said transaction information is processed or selected by the chip of the device.

8. The method according to one of the preceding claims, characterized in that said adapter comprises a cell phone, a wireless earpiece provided with a communication interface adapted to that of the communication interface of the carte.

9. The method according to one of the preceding claims, characterized in that said adapter (4) is selected from a user device such as a cell phone, a tablet, a personal assistant, a wearable electronic accessory, a smart or NFC watch).

10. The method according to one of the preceding claims, characterized in that the reader comprises a POS reader or ATM banking terminal.

11. The method according to one of the preceding claims, characterized in that said adapter comprises a software application configured to translate or transpose digital or analog information into voice or another type of information on a human-machine interface and vice-versa.

12. A system for performing a transaction with a system (1, 1A, 1B, 10) comprising a terminal (2) and a chip device (3), said system being configured to communicate to a user (6), during said transaction, transaction information from the terminal via an adapter (4), said adapter being configured to receive, by wire or wirelessly, said information (5) and to translate it into voice or another form, said information being obtained or collected in or via said chip device (3),
characterized in that said chip device (3) is configured with a first communication interface with proximity radiofrequency or electrical contacts (M3) included in the device in order to receive the transaction information directly from a communication interface of the terminal.

13. A chip device (3) for performing a transaction with a terminal (2) according to the method of any of claims 1 to 11, characterized in that it is configured so as to obtain or collect information (5, 15) of transactions with said terminal (2) and to communicate (5) said information to an associated adapter (4).

14. A transaction adapter (4) for implementing the method of any of claims 1 to 11, said adapter being configured to receive, by wire or wirelessly, transaction information (5, 15) from a terminal (2) and to translate it into voice or another form, during a transaction,
characterized in that it is paired with a chip device according to claim 13 so as to receive said transaction information (5, 15).
